(19) United States
(12) Patent Application Publication
(10) Pub. No.: US 2007/0138724 A1
(43) Pub. Date: Jun. 21, 2007

(54) Clamp Device

(75) Inventors: Louis Gibbons, Stevensville, MD (US); David C. Campbell, Bel Air, MD (US); James D. Marshall, Mallorytown, ON (CA); Wade C. King, Finksburg, MD (US); Thomas Murray, Baltimore, MD (US); Michael H. Kott, Baltimore, MD (US); Joe Rogers, Jarrettsville, MD (US); Rodney Milbourne, Abington, MD (US)

Correspondence Address: EDELL, SHAPIRO & FINNAN, LLC, 1901 RESEARCH BOULEVARD, SUITE 400, ROCKVILLE, MD, 20850, US

(73) Assignee: BLACK & DECKER, Newark, DE (US)

(21) Appl. No.: 11/611,372

(22) Filed: Dec. 15, 2006

Related U.S. Application Data
(60) Provisional application No. 60/750,798, filed on Dec. 16, 2005.

(51) Int. Cl. B25B 1/10

(52) U.S. Cl. 269/249

(57) ABSTRACT

A handheld, portable, motorized clamping device is disclosed. The device includes a housing, a frame, a stationary clamp member, and a displaceable clamp member. The displaceable clamp member may be repositioned by a drive assembly, or may be manually adjusted. In another embodiment of the invention, the stationary clamp member may be repositioned on the frame to alter the dimensions of the clamp opening. In still another embodiment, the clamp device operatively connects to a secondary tool that engages the drive assembly.

### CROSS-REFERENCE TO RELATED APPLICATIONS

This application is a nonprovisional of U.S. Provisional Application 60/750,798, filed 16 Dec. 2005 and entitled “Clamp Device”, the disclosure of which is hereby incorporated by reference in it entirety.

### FIELD OF THE INVENTION

The present invention relates to a device that applies pressure to a workpiece and, more particularly, to a motorized, handheld C-clamp.

### BACKGROUND

Clamping devices are used in many trades, including applications by framers, mechanics, and carpenters. Clamps of various designs and shapes are used for a variety of purposes. Typically, they require manual adjustment to increase or decrease the width between the clamp ends. Manual adjustment can be time consuming, tedious, and fatiguing when the worker is required to open and close the clamp numerous times. Manual adjustment clamps can also be burdensome, for example, when the worker must operate the clamp repeatedly during a short period of time. Another drawback of traditional clamp designs is the slow operation of the clamp when being manually adjusted by the operator. Turning a clamp end to slowly increase or decrease the spacing between the ends is a time consuming task.

Traditional clamp designs further require that both hands of the operator be used to tighten and loosen the clamp. Oftentimes, however, the operator has a need to use one hand for holding the object to be clamped. The requirement for holding the objects arises, for example, when a specific alignment is desired between the object and the clamp or when an object needs to be held stable as the clamp is applied. Specific alignment of the objects prior to clamping is particularly challenging when there are several objects to be aligned and clamped simultaneously. Thus, it can be very unwieldy, frustrating, and time consuming for one operator to attempt to hold the objects and operate the clamp simultaneously.

To compound the problem, an operator is unable to readily determine the correct amount of pressure to place on a work piece since there is no indicator to tell the operator how much pressure the clamp is exerting. The application of too much pressure to a work piece could damage or mar the work piece.

Consequently, there is a need to provide a handheld clamp that addresses the above deficiencies.

### SUMMARY OF THE INVENTION

The present invention is directed toward a powered C-clamp device including a housing, a frame, a stationary clamp member, and an axially displaceable clamp member. The displaceable clamp member is controlled by a drive assembly including a control element configured to selectively engage the clamp member. In another embodiment of the invention, the stationary clamp member may be repositioned on the frame to alter the dimensions of the clamp opening. In still another embodiment, the clamp device operatively connects to a secondary tool that engages the drive assembly.

### BRIEF DESCRIPTION OF THE DRAWINGS

FIGS. 1A and 1B illustrate front and rear perspective views, respectively, of a clamp device in accordance with an embodiment of the invention.

FIG. 2 illustrates a the clamp device of FIG. 1A, with the housing removed for clarity.

FIG. 3 illustrates a close up view of the motor assembly of the clamp device of FIG. 2.

FIG. 4 illustrates a close-up view of the drive assembly of the clamp device of FIG. 2.

FIG. 5 illustrates an exploded view of the motor assembly and the drive assembly in isolation.

FIGS. 6A and 6B illustrate the operation of a screw leg release mechanism in accordance with an embodiment of the invention.

FIGS. 7A, 7B, and 7C illustrate front views of a clamp device in accordance with another embodiment of the invention.

FIGS. 8A and 8B illustrate perspective views of a clamp device according to another embodiment of the invention.

FIGS. 9A-9C illustrate a screw leg release mechanism according to another embodiment of the invention.

FIGS. 10A-10C illustrate exploded and side views of an actuator in accordance with another embodiment of the invention.

FIG. 11 illustrates a front view of a clamp device according to another embodiment of the invention.

Like reference numerals have been used to identify like elements throughout this disclosure.

### DETAILED DESCRIPTION

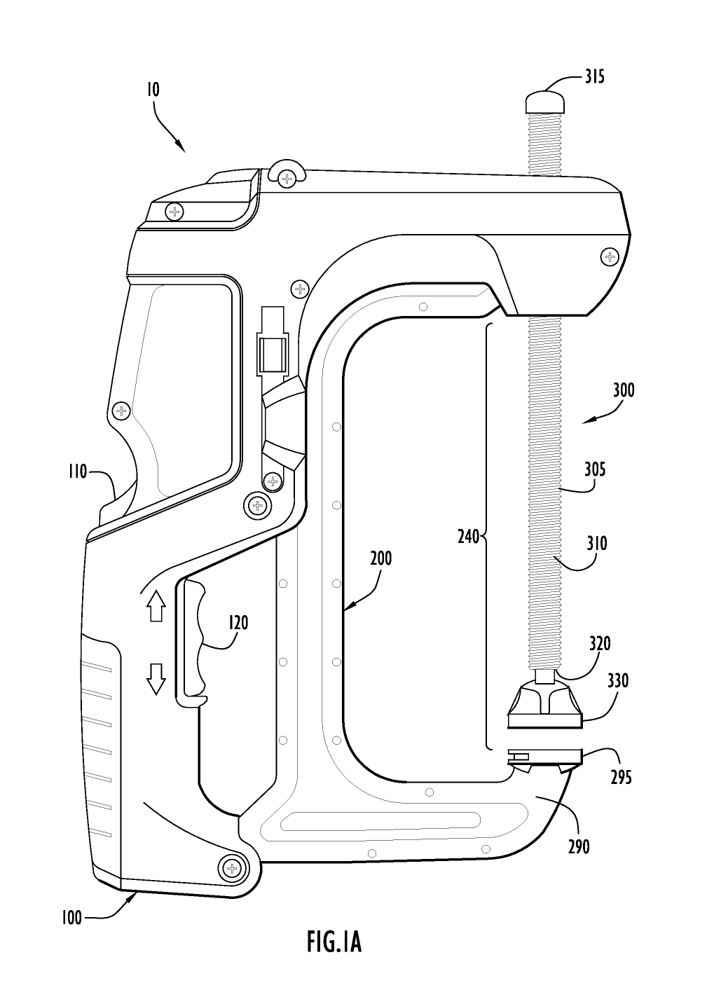

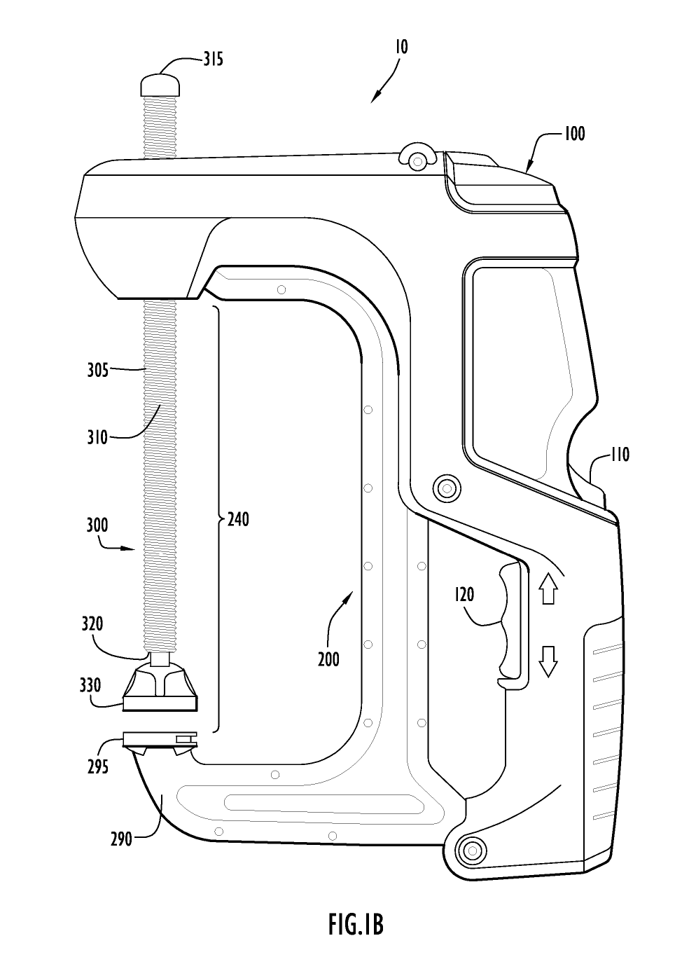

FIGS. 1A and 1B illustrate front and rear views, respectively, of a clamp device according to an embodiment of the invention. As illustrated, the clamp device 10 may include a housing or shell 100, a skeleton or frame 200, and a displaceable clamp member or screw leg 300. The housing 100 contains various mechanical components of the clamp device 10 including, but not limited to, a motor assembly, a power source, etc. The housing 100 may be formed from a hard, impact-resistant, preferably moldable material such as a hard thermoplastic material such as ABS or polystyrene. The housing 100 may also include a grip portion formed from soft or low durometer thermoplastic elastomer. For example, a grip portion may be adhered or overmolded to the housing 100. Alternatively or additionally, the grip portion may be formed from “soft-touch” elastomer materials such as SANTOPRENE, KRATON, and MONOPRENE.

The clamp device 10, and specifically, the housing 100, may include one or more actuators operable to control the various components of the clamp device 10. For example, in the embodiment of FIGS. 1A and 1B, the housing 100 includes a first actuator 110 and a second actuator 120. The first actuator 110 may operate a control element (also called a release mechanism) for the screw leg 300 (discussed in greater detail below). The second actuator 120 may selectively engage and disengage a motor in a desired direction (also discussed in greater detail below). The types of actuators 110, 120 envisioned herein may include, but are not limited to, mechanical switches (pressure switches, slide buttons, etc.), electrical switches, etc. In addition, the clamp device 10 may further include a third actuator such as a turn knob (not illustrated) that manually operates the screw leg 300.

The housing 100 may further include a display (not illustrated) operable to provide information related to the clamp device 10. By way of example, the display may comprise information relating to the operational status of the clamp device 10 (on, off, charging, etc.), the battery life (e.g., a “low battery” indicator, or a series of bars illustrating the strength of the battery), the direction in which the motor is driving the screw leg 300 (forward/reverse), and/or the pressure being applied to a workpiece by the screw leg 300 (e.g., via specific pressure units, or a high/low pressure indicators having a high/low values based on a predetermined threshold). The manner in which information is provided by the display includes, but is not limited to, digital display, lights (e.g., LEDs), mechanical dials and/or needles, audio signals, etc.

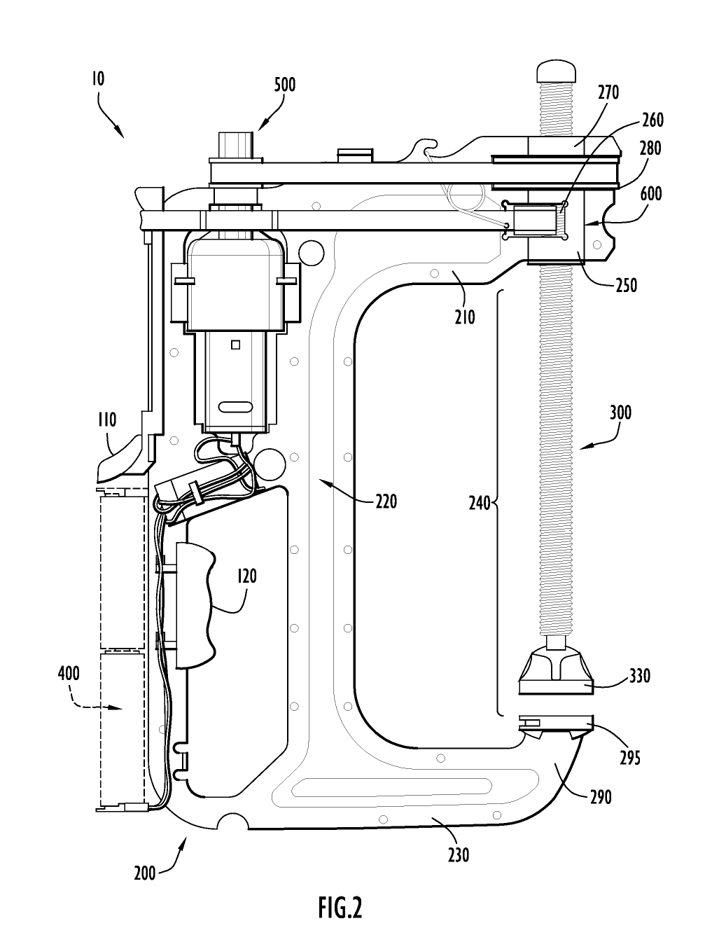

The skeleton or frame 200 is configured to support to the components of the clamp device 10, e.g., as it exerts pressure on a workpiece. FIG. 2 illustrates a front view of the clamp device 10 of FIG. 1A, with the housing 100 removed for clarity. In the illustrated embodiment, the frame 200 possesses a generally C-shaped or G-shaped configuration including an upper frame portion or support 210 (to top of the “C”), an intermediate frame portion or support 220, and a lower frame portion or support 230 (the bottom of the “C”). The frame portions 210, 220, 230 define an opening 240 operable to receive a workpiece (i.e., the object or objects to be clamped). The upper frame portion 210 may further include a chamber 250 with a window 260, as well as a guide member 270 spaced above the chamber. The chamber 250 and the guide member 270 may each include channels that are generally aligned to permit the passage of the screw leg 300 into the frame opening 240. The space between the guide member 270 and the chamber 250 forms a cavity 280 into which a drive gear of the drive assembly may be positioned (discussed in greater detail below).

The lower frame portion 230 may form a stationary clamp member 290 generally aligned with the screw leg 300. The clamp member 290 may include a platform 295 configured to engage a footpad disposed on the screw leg 300. The platform 295 may be fixed, or may swivel, e.g., via a ball joint connection.

Referring back to FIG. 1A, the shaft member or screw leg 300 is axially displaceable within the opening 240 of the frame 200, and is configured to engage and apply pressure to a workpiece (i.e., the object or objects to be clamped). As illustrated, the screw leg 300 may comprise a generally cylindrical shaft 305 with threads 310 formed thereon. The threaded shaft 305 includes a proximal end 315 and a distal end 320. A notch or slot 325 (seen in FIG. 5) formed into the shaft 305, may be configured to receive/engage a tab disposed on the drive gear (discussed in greater detail below). The distance the slot 325 runs along the screw leg 300 is not particularly limited. By way of example, the slot 325 may extend substantially along the entire length of the screw leg 300.

Referring to FIG. 2, the screw leg 300 passes through the channel of the guide member 270 and the chamber 250 such that the shaft proximal end 315 is generally positioned above the upper frame portion 210, while the shaft distal end 320 is positioned below the upper frame portion 210 and within the frame opening 240. A footpad 330, configured to align with the platform 295 of the stationary clamp member 290, may be coupled to the shaft distal end 320. The footpad 330 may be fixed to the shaft 305 or may swivel, e.g., via a ball joint connection.

The clamp device 10 may further include a power source 400, a motor assembly 500, and/or a drive assembly 600. The power source 400, which may be operatively connected to the motor assembly 500, provides power to the clamp device 10. Any power source 400 sufficient to power the motor assembly 500 may be utilized, including, but not limited to, direct current sources, alternating current sources, etc. By way of specific example, the power source 400 may comprise a battery power source (e.g., two “AA” alkaline batteries, rechargeable batteries, etc.).

The motor assembly 500 is configured to selectively engage the drive assembly 600, generating motion in a desired direction. FIGS. 3-5 show the motor and drive assemblies of the clamp device 10 according to embodiments of the invention. First turning to FIG. 3, showing a close-up view of the motor assembly 500, the motor assembly 500 may include a motor 510, a transmission or clutch mechanism 520, and a drive shaft 530. The motor 510 may include, but is not limited to, a reversible/bi-directional motor. The transmission may include any device operable to transmit the power of the motor 510 to the drive shaft 530 and/or provide a variable driving force to the drive shaft 530. In operation, the motor 510 rotates the drive shaft 530 about its longitudinal axis, which, in turn, engages the drive assembly 600.

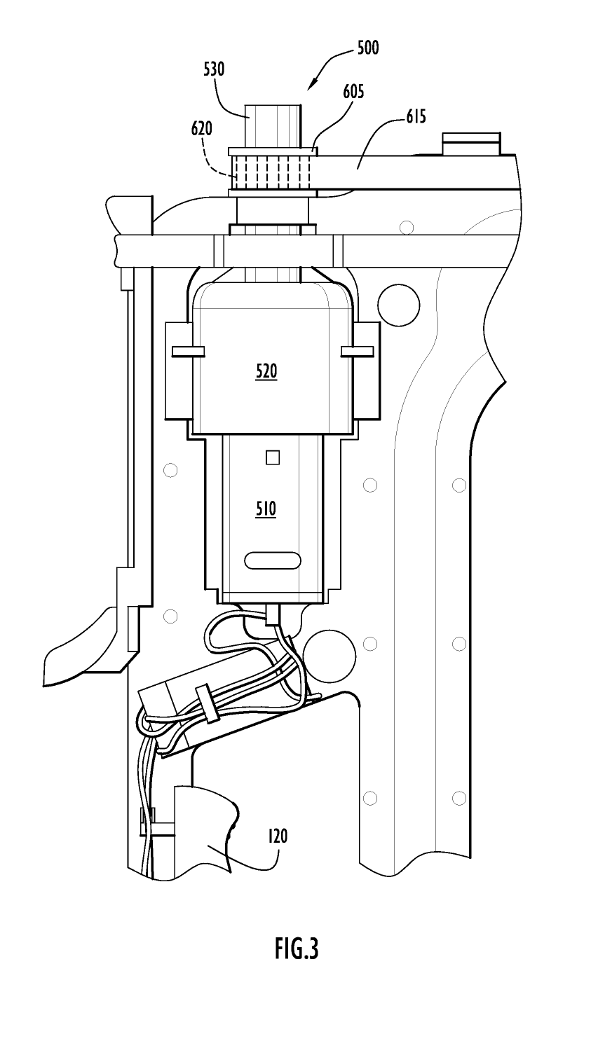

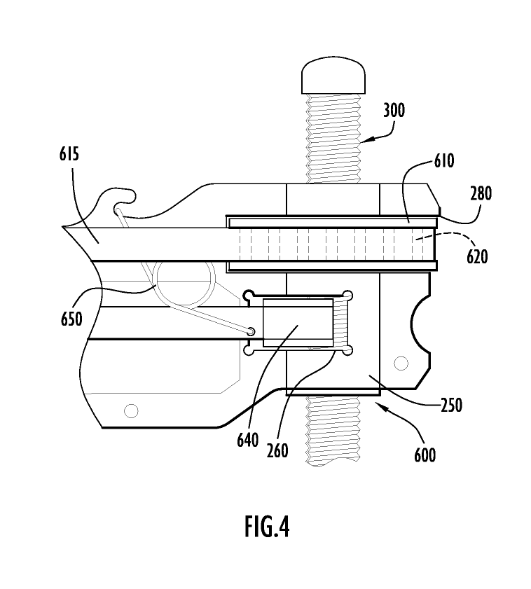

The drive assembly 600 transfers the rotary motion of the motor 510 to the screw leg 300. FIG. 4 illustrates a close-up view of the drive assembly 600 in accordance with an embodiment of the invention. As shown, the drive assembly 600 may include a first drive gear 605 (seen in FIG. 3) in communication with a second drive gear 610 via a drive belt 615. The first drive gear 605 is coupled to the drive shaft 530 of the motor assembly 500 such that, as the motor 510 rotates the drive shaft 530 about its axis, the first drive gear 605 rotates. The first drive gear 605 may include, but is not limited to, conventional gears, sprockets, cogs, pulleys, etc. By way of specific example, the first drive gear 605 may possess a generally annular shape including teeth 620 operable to mesh with the teeth of the drive belt 615.

The second drive gear 610 may be configured to rotate the screw leg 300 in, e.g., clockwise and/or counterclockwise directions. As mentioned above, the second drive gear 610 may be disposed within the cavity 280 formed into the upper frame portion 210. The second drive gear 610 may include, but is not limited to, conventional gears, sprockets, pulleys, cogs, etc. In the embodiment illustrated, the second drive gear 610 has a generally annular shape with an opening 625 sized to permit the screw leg 300 to pass therethrough (best seen in FIG. 5). The second drive gear 610 further includes a flange 630 with a boss or tab 635 extending radially into the opening 625. The tab 630 is configured to engage the slot 325 of the screw leg 300, becoming trapped therein. Thus, as the first drive gear 605 rotates, the screw leg 300 rotates (discussed in greater detail below). Similar to the first drive gear 605, the exterior surface of the second drive gear 610 includes teeth 620 that mesh with teeth 617 on the drive belt 615.

The drive belt 615 may include any belt operable to transmit power from the first drive gear 605 to the second drive gear 610. By way of example, the drive belt 615 may include, but is not limited to, chains, flat belts, round belts, as well as toothed (notch or cog) belts. In the embodiment illustrated in FIGS. 3-5, the drive belt 615 is a serrated drive belt including teeth 617 configured to mesh with the teeth 620 formed in each of the drive gears 605, 610.

The drive assembly 600 may further include a control element (also called a release mechanism) operable to selectively engage the threads of the screw leg 300 to cause the rotation of the shaft 305 to result in the axial displacement of the screw leg 300 toward or away from the stationary clamp member 290. FIG. 5 is an exploded view of the motor assembly 500 and the drive assembly 600 in isolation. In the illustrated embodiment, the control element includes an open collar 640 including threads 645 complementary to the threads 310 of the screw leg 300. By way of example, the collar 640 may be an opened channel having a generally C-shaped configuration. By way of further example, the collar 640 may be formed from a threaded nut fastener cut in half. A biasing member 650 (e.g., a spring as seen in FIG. 4) urges the collar through the window 250 of the chamber 260, biasing the collar 640 into engagement with the screw leg 300. In operation, when the collar 640 is in its normal, engaged position, rotation of the screw leg 300 (either clockwise or counterclockwise), in combination with the engaged threads 310, 645, draws the screw leg 300 through the chamber 250, causing the translational motion of the screw leg toward or away from the stationary clamp member 290.

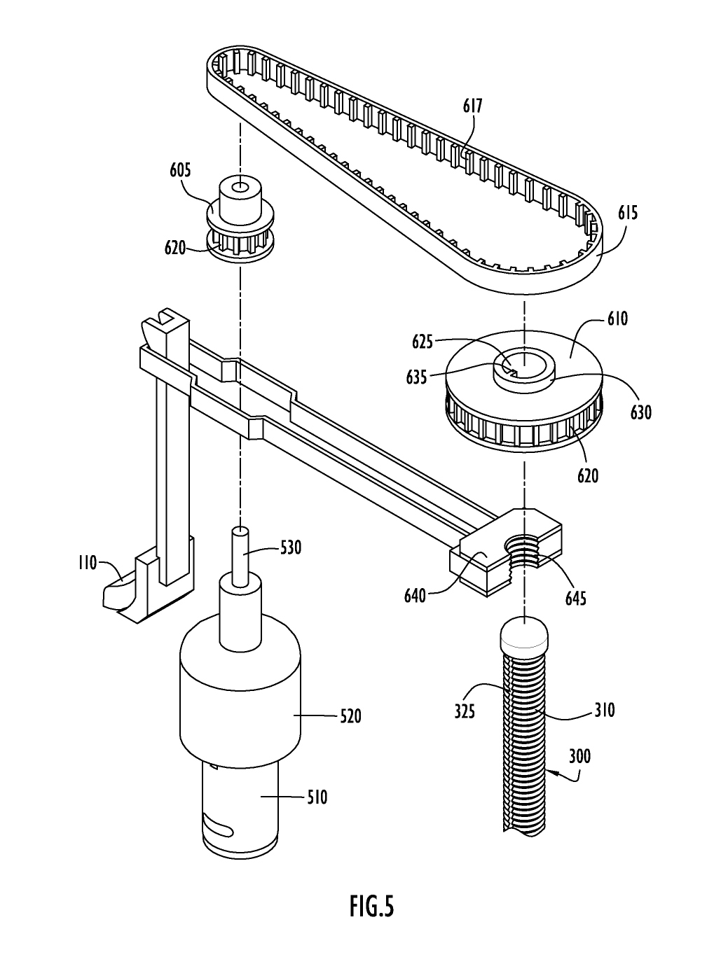

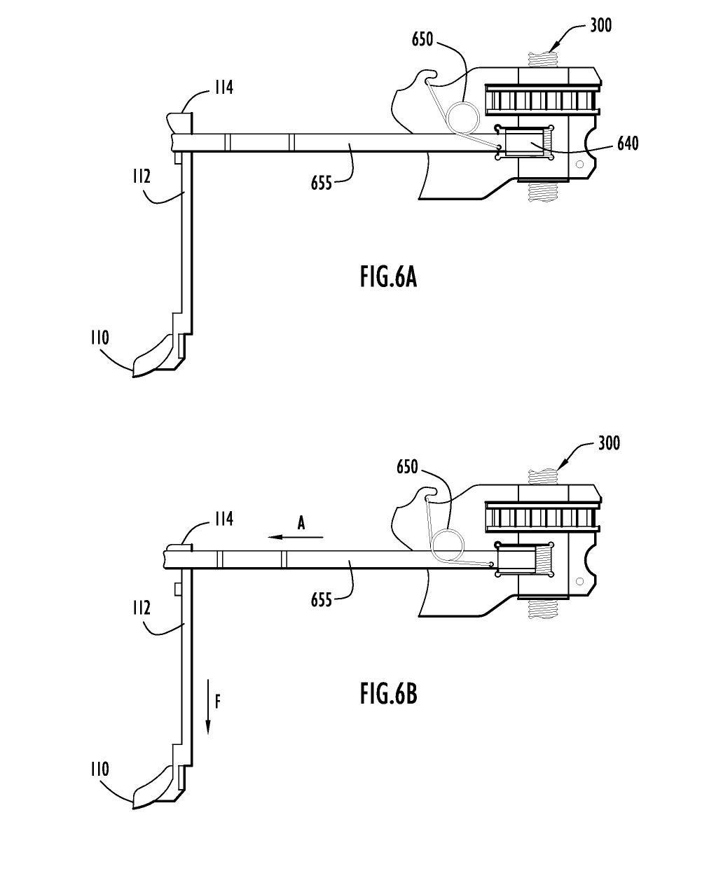

The control element may further be configured to selectively disengage the screw leg 300. FIGS. 6A and 6B illustrate the operation of a screw leg release mechanism in accordance with an embodiment of the invention. As shown, the collar 640 may be coupled (e.g., mechanically linked) to an arm 655, which, in turn, is coupled to the first actuator 110. The first actuator 110 may include a post 112 and a ramp 114 configured to selectively engage the arm 655. In FIG. 6A, first actuator 110 is in its normal or first position, in which the collar 640 is biased into engagement with the screw leg 300. Applying a force to the first actuator 110 (indicated by arrow F) drives the first actuator downward from the first position to a second position (FIG. 6B). In the second position, the ramp 114 is positioned within the end of the arm 655, pushing the arm outward (indicated by arrow A), and overcoming the force of the biasing member 650. This, in turn, draws the collar 640 away from the screw leg 300, disengaging their respective threads 645, 310. As a result, although the motor assembly 500 rotates the screw leg 300, the screw leg is not axially displaced because the collar 640 is disengaged. With the collar 640 disengaged, the screw leg 300 is generally freely moveable along its axis. Consequently, the screw leg 300 may be repositioned (i.e., axially displaced) simply by applying a force thereto. Specifically, the tab 635 extending from the second drive gear 610 slides along the slot 325 formed in the screw leg 300. As such, the screw leg 300 is free to travel along the tab 635, with the guide member 270 and the tab functioning to help guide the screw leg in a generally up and down direction. Releasing the first actuator 110 returns the collar 640 back to the first position, with the collar engaging the screw leg 300.

With the above described configuration, the control element (i.e., the collar 640) provides the clamp device 10 with a “quick release” mechanism that permits the immediate disengagement of the screw leg 300 from the motor assembly 500 and allows an operator to adjust the position of the screw leg without utilizing the motor 510. For example, engaging the quick release mechanism permits an operator to disengage a workpiece by simply engaging the first actuator 110, and not requiring the user to reverse the motor 510 to draw the screw leg 300 away from/out of contact with the workpiece.

Operation of the clamp device 10 is explained with reference to FIGS. 2-6. Power is provided to the clamp device 10 via the power source 400. The motor 510 is engaged in either a first (e.g., forward) or a second (e.g., reverse) direction by engaging the second actuator 120. When engaged, the motor 510 rotates the drive shaft 530 in a predetermined direction, which, in turn, rotates the first drive gear 605. The first drive gear 605 engages the drive belt 615, which, in turn, rotates the second drive gear 610. As explained above, the tab 635 of the second drive gear 610 is positioned within the slot 325 of the screw leg 300; consequently, rotation of the second drive gear 610 causes a corresponding rotation in the screw leg 300. When the collar 640 threadingly engages the screw leg 300, the screw leg is axially displaced as described above. The direction of displacement is controlled by controlling the rotational direction of the motor 510. Thus, the screw leg 300 may be automatically controlled simply by engaging the second actuator 120, enabling single-handed operation of the clamp 10 as it acts on a workpiece. That is, since the clamp device may be configured as a portable, handheld tool, an operator may position and engage the second actuator 120 using only one hand. Once clamping of the workpiece is complete, an operator may either reverse the motor direction to disengage the clamp device 10, or may simply engage the first actuator 110 to activate the quick release mechanism.

In addition, the screw leg 300 may be manually rotated through the manipulation of a key or handle (not illustrated). For example, the clamp device 10 may include a handle that permits the user to manually rotate the screw leg 300 clockwise or counterclockwise (e.g., the proximal end 315 of the screw leg may have a T-handle coupled thereto). Alternatively, clamp device 10 may include a socket in communication with the drive assembly 600. A key may connect to the socket to rotate a drive gear 605, 610 in a desired direction and displace the screw leg 300.

The clamp device 10 may further include a sensor that measures and/or displays (on display) the amount of pressure being applied by the screw leg 300 on the work piece (not illustrated). For example, a spring (e.g. a torsion spring) may be coupled to both the motor 510 and a dial. The dial may be configured as part of the housing display, discussed above. The display, furthermore, may include indicia indicative of pressure applied to the spring (e.g., numerical values, high/medium/low, etc.). The spring is set to the limit of the motor; consequently, as the motor 510 rotates (and the screw leg 300 moves towards a work piece), the load on the spring changes, causing a corresponding movement in the dial. The dial points to appropriate indicia, informing a user of the relative amount of force being applied to the work piece by the screw leg 300. Neither the measurement nor the indication of pressure is limited to the above-referenced embodiment. For example, the clamping pressure indicator could take the form of LEDs or lamps that indicate high and low pressure; a gauge comprising a crushable elastic material that bulges to increasingly larger diameters as pressure increases; and/or other mechanical indicators dependent on clamp displacement (e.g., a gauge, scale, or pointer). Alternatively, the footpad 330 on the screw leg 300 or the platform 295 on the stationary clamp member 290 may include a pressure-sensitive pad capable of providing a visual change as the amount of pressure on the footpad 330 or the platform 295 increases. For example, a urethane pad that changes colors with changing pressure may be used. In addition, the clamping pressure indicator may comprise electronic sensors (e.g., a current limiting resistor on a selector switch to limit motor power) or a mechanical clutch on the transmission that limits power to the screw leg 300.

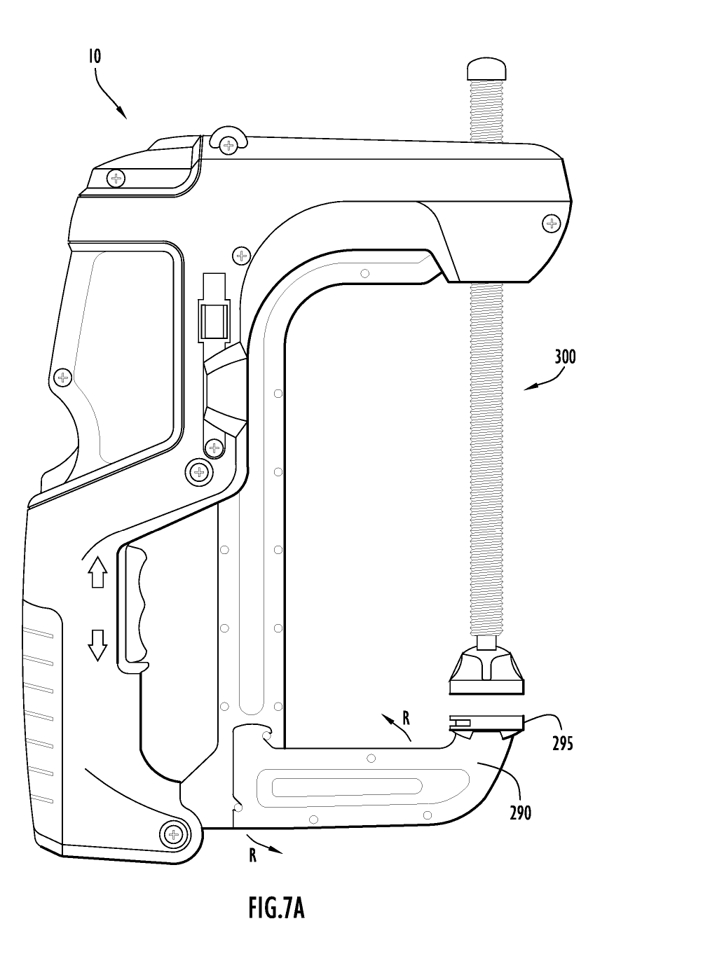

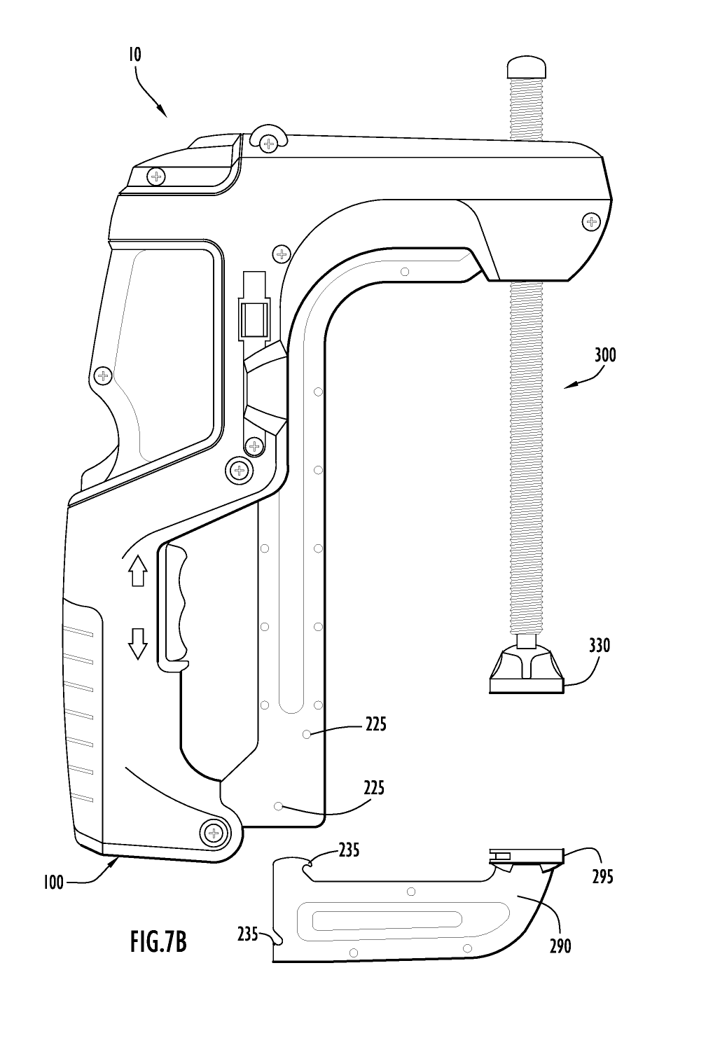

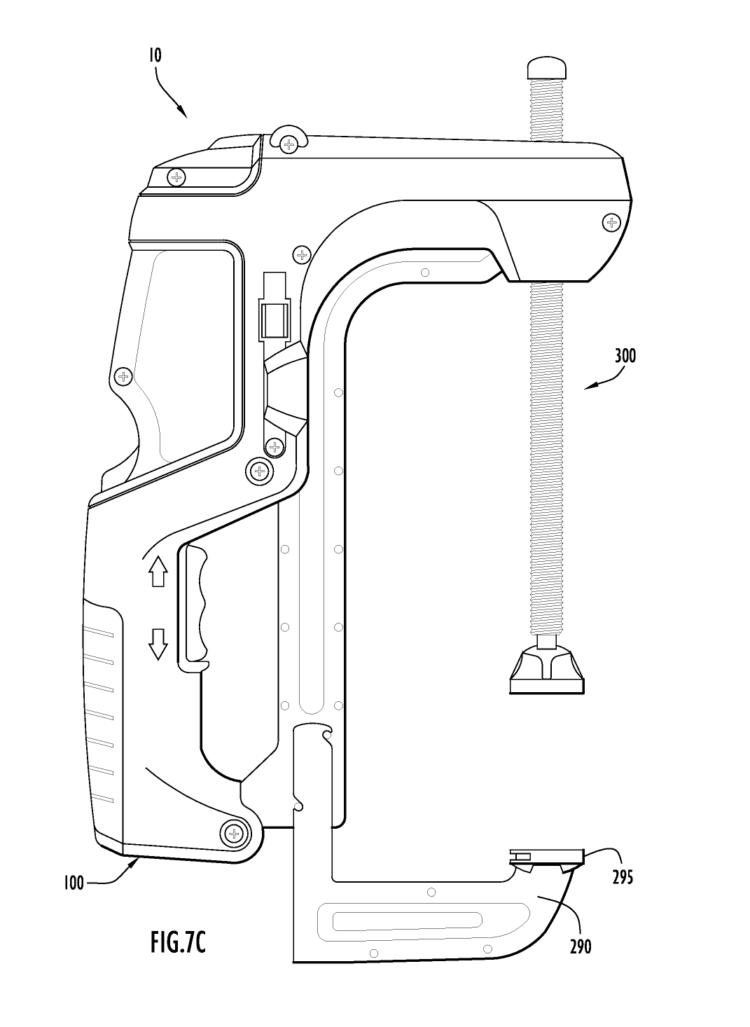

In another embodiment of the invention, the clamp device 10 may be adapted such that the stationary clamp member 290 is repositionable on the frame 200 to alter dimensions of the frame opening 240. FIGS. 7A, 7B, and 7C are front views of a clamp device 10 according to another embodiment of the invention. As illustrated, the lower frame portion 230 (and, specifically, the stationary clamp member 290) is detachable from the intermediate frame portion 220. The lower frame section 230 includes one or more hooks 235 adapted to connect to corresponding posts 225 formed on the intermediate frame portion 220. Rotating the stationary clamp member 290 (indicated by arrows R) removes the posts 225 from the hooks 235. With this configuration, the lower frame portion 230 is interchangeable with other lower frame portions having various dimensions. As shown in FIG. 7C, a stationary clamp member having a longer body may be used.

Alternatively, additional posts 225 may be provided on the frame 200 to enable the repositioning of a single lower frame portion 230 along the intermediate frame portion 220. In this manner, a single lower frame portion may be used to alter the dimensions of the frame opening 240. It is important to note that, while hooks are illustrated, any suitable fasteners may be used, including, but not limited to, snap, screws, etc.). Alternatively, the lower frame portion 230 may be telescopically extendable from the intermediate frame portion 220 and may include a lock to selectively secure the lower frame portion 230 at varying extension amounts.

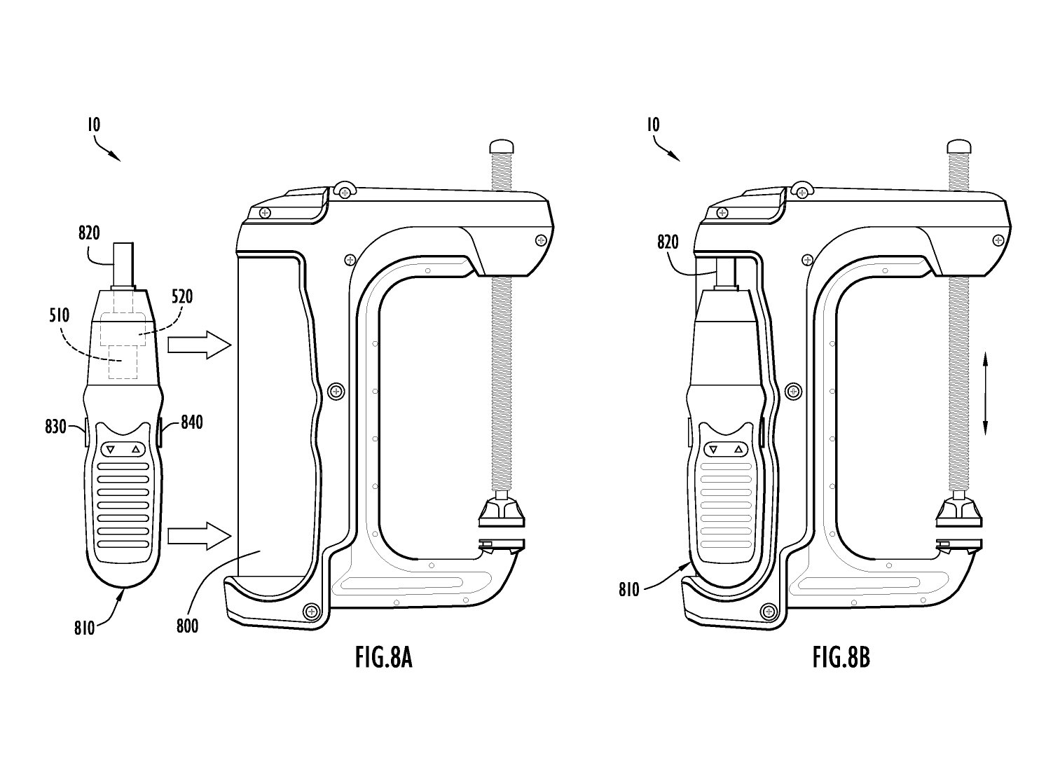

The clamp device 10 of the present invention may be further modified to receive a removable power/motor assemblies. FIGS. 8A and 8B illustrate perspective views of a clamp device 10 according to another embodiment of the invention. As shown, the clamp device 10 includes a structure similar to that as described above, including a frame 200 that supports a screw leg 300 controlled by a drive assembly 600. The housing 100, however, now includes a receptacle 800, and the power assembly 400 and the motor assembly 500 of the clamp device 10 have been omitted. The housing 100, moreover, is adapted to couple with removable power and/or motor assemblies. By way of example, the housing 100 may be adapted to receive a secondary power tool such as a motorized screw driver 810. The screwdriver 810 contains a power assembly 400 and a motor assembly 500 including the motor 510 and the transmission/clutch mechanism 520 similar to those discussed above. By way of specific example, a conventional battery powered screwdriver such as the AS600 Alkaline Battery Screwdriver (available from Black & Decker, Towson, Md.) may be utilized as the secondary tool containing motor and power assemblies. The screwdriver 810 includes a motor 510 operable to rotate a bit holder 820 in clockwise and/or counterclockwise directions (as controlled by switches 830, 840). The clamp device 10, moreover, couples to the bit holder 820 of the screwdriver 810. Specifically, a boss in communication with first drive gear 605 may extend into the receptacle 800. The boss mates with the bit holder 820 of the screwdriver 810 such that, as the bit holder 820 rotates, the first drive gear 605 rotates. In other words, the bit holder 820 and boss collectively serve as the drive shaft of the motor assembly, engaging the drive assembly 600 in a manner similar to that discussed above. Specifically, engaging the motor 510 contained in the screwdriver 810 engages the drive assembly 600 contained in clamp device 10, displacing the screw leg 300 in manner similar to that described above. In this manner, a system including the clamp device 10 and a secondary tool is provided.

While the invention has been described in detail and with reference to specific embodiments thereof, it will be apparent to one skilled in the art that various changes and modifications can be made therein without departing from the spirit and scope thereof. For example, although a handheld device is illustrated, the housing 100 may be of any shape and possess any dimensions suitable for its intended purpose. The housing 100 may be formed from any suitable materials. Similarly, the frame 200 may possess any shape and dimensions and may be formed from any suitable materials.

The motor assembly 500 may include a crank arm that permits the manual rotation of the drive shaft 530 to enable movement of the screw leg 300 without engaging the motor 510. Similarly, the drive assembly 600 may further include a crank arm that permits the manual rotation of the first drive gear 605 or the second drive gear 610, enabling the axial displacement of the screw leg 300 without engaging the motor 510.

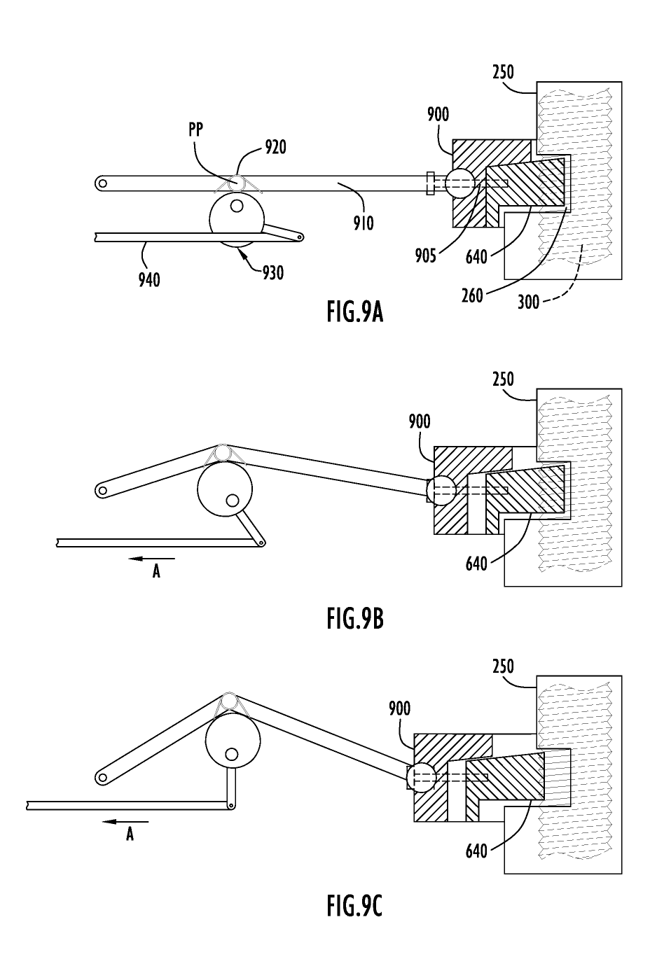

The control element/release mechanism may include any structure suitable for its described purpose. FIGS. 9A-9C illustrate a control element/release mechanism according to another embodiment of the invention. As shown, the mechanism that engages and releases the screw leg 300 may include a wedge block 900 connected to the collar 640 via a rod 905. The wedge block 900 is coupled to a lever 910 including a pivot point PP. The lever 910 is spring biased into engagement with the screw leg 300 via a biasing member 920 (e.g., a spring). The lever 910 may be selectively pivoted by engaging a toggle switch 930 (e.g., a toggle with a lockout cam) activated by an arm 940 in communication with the first actuator 110 (the first actuator is not illustrated in FIGS. 9A-9C). In operation, engaging the first actuator 110 laterally moves the arm 940 (indicated by arrow A) to activate the toggle switch 930. The toggle switch 930, in turn, overcomes the biasing force of the biasing member 920, pivoting the lever 910 from a first position, in which the wedge block engages the collar 640, pressing it into contact with the screw leg 300 (FIG. 9A), to a second position, in which the wedge block 900 disengages the collar 640 (FIG. 9C). As the wedge block moves laterally away from the collar 640, the rod 905 pulls the collar out of engagement with the threads. Thus, in the second position, the screw leg 300 is free to translate without the aid of the motor 510, as described above. Releasing the first actuator 110 returns the wedge block 900 to its original position, urging the collar into engagement with the screw leg 300.

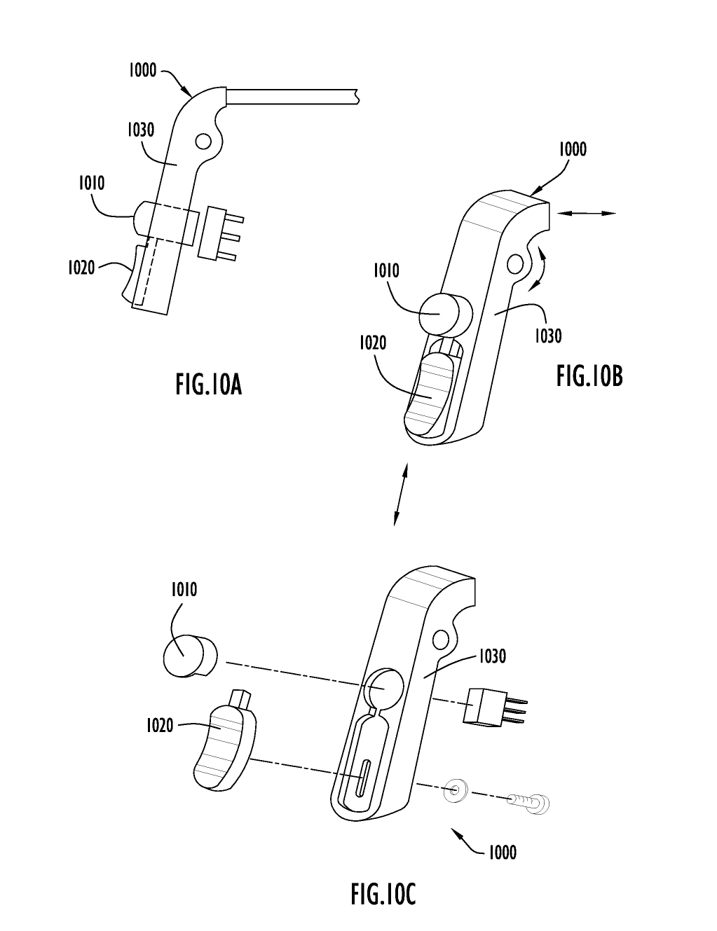

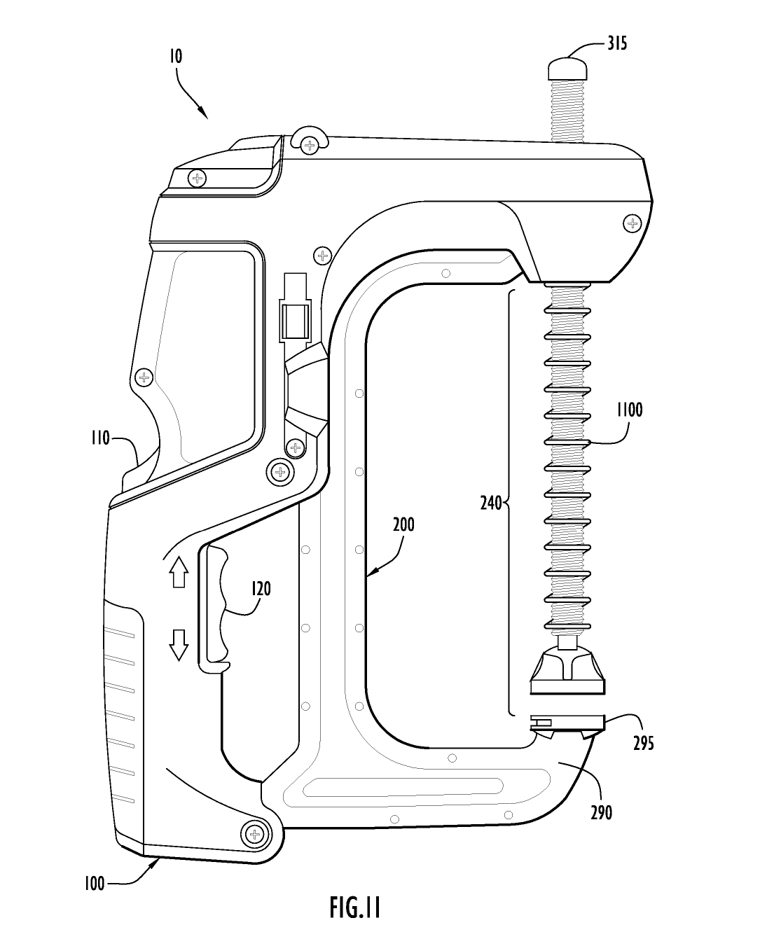

The first 110 and/or second 120 actuators may be any actuators suitable for their described purposes. The first and second actuators, moreover, may be combined into a single actuator. FIGS. 10A-10C illustrate exploded and side views of an actuator in accordance with another embodiment of the invention. As shown, the actuator 1000 may comprise a button 1010, a slide lock 1020, and a lever 1030. The button 1010 may be utilized to operate the motor 510, while the slide lock 1020 may be utilized to lock out the button 1010 (when the slide lock is engaged, the button 1010 cannot be operated/depressed) as a safety mechanism. Finally, the lever 1030 may be utilized to operate the release mechanism for the screw leg 300 (by engaging and disengaging the collar 640).

The screw leg 300 may also possess any suitable dimensions and/or shape. Referring to FIG. 11, the clamp device 10 may further include a biasing member (also called an expansion member) operable to displace the screw leg 300 toward the stationary clamp member 290, enabling closure on a work piece without the aid of the motor 510. For example, the expansion member may include a spring 1100 that surrounds the screw leg 300. The spring 1100 is compressible, permitting a user to load the spring by pressing it toward the upper frame portion. The control element may secure the loaded screw leg 300 in place. Consequently, when the first actuator 110 is engaged, releasing the screw leg 300, the spring 1100 expands, axially displacing the screw leg. Alternatively, a latch (not illustrated) may secure the spring in its loaded position. An actuator may be configured to release the latch, permitting the spring 1100 to expand. The expanding spring urges the screw leg 300 toward the platform 295 of the stationary clamp member 290, and, specifically, the workpiece. With the above-described configurations, further one-handed operation features may be provided.

The clamp device 10, moreover, may be configured as an arbor press. For example, the lower frame portion 230 may be replaced with a bracket operable to secure the clamp device 10 to a work surface. Once secure, the screw leg 300 may be driven towards the work surface, functioning as a press.

Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

We claim:

1. A handheld clamp device comprising:
a stationary clamp member;
a displaceable clamp member;
a drive assembly operatively connected to the displaceable clamp member; and
a motor assembly operatively connected to the drive assembly,
wherein the drive assembly includes a control element operable to cause the axial displacement of the displaceable clamp member, and wherein the control element is selectively moveable from a first position, in which the control element engages the displaceable clamp member, to a second position, in which the control element disengages the displaceable clamp member.

2. The clamp device of claim 1, wherein:
the displaceable clamp member comprises a threaded shaft; and
the control element comprises an threaded collar configured to engage the threaded shaft.

3. The clamp device of claim 2, wherein the threaded collar comprises a generally C-shaped structure including an open channel.

4. The clamp device of claim 1, wherein the control element is displaceable along an axis generally transverse to an axis of displacement of the displaceable clamp member.

5. The clamp device of claim 1 further comprising:
an arm mechanically linked to the control element; and
a first actuator mechanically linked to the arm such that engaging the arm moves the control element from the first position to the second position.

6. The clamp device of claim 1 further comprising a slot formed in the displaceable clamp member, wherein the drive assembly further comprises a drive gear including a tab configured to mate with the slot.

7. The clamp device of claim 6, wherein:
the drive gear comprises an annular gear including an interior channel;
the tab extends into interior channel; and
the displaceable clamp member is coupled to the drive gear via the tab such that the rotation of the drive gear causes a corresponding rotation of the displaceable clamp member.

8. The clamp device of claim 1, wherein, in the second position, the displaceable clamp member is freely moveable along its longitudinal axis.

9. The clamp device of claim 1, wherein, in the second position, the position of the displaceable clamp member is adjustable without the aid of either the motor or the drive assembly.

10. The clamp device of claim 1 further comprising:
a biasing member operable to bias the control element in the first position;
a release mechanism operable to retract the control element, moving it from the first position to the second position.

11. The clamp device of claim 1, wherein the stationary clamp member is removable from the clamp device.

12. The clamp device of claim 11, wherein the stationary clamp member is repositionable on the clamp device.

13. The clamp device of claim 11, further comprising a biasing member operable to axially displace the displaceable clamp member without the aid of the motor.

14. The clamp device of claim 13, wherein the biasing member comprises a spring disposed around the displaceable clamp member.

15. A clamp device comprising:
a stationary clamp member;
a displaceable clamp member comprising a slot formed therein;
a drive assembly operatively connected to the displaceable clamp member; and
a motor assembly operatively connected to the drive assembly,
wherein the drive assembly includes a drive gear including a tab configured to mate with the slot such that the movement of the drive gear causes a corresponding movement in the displaceable clamp member.

16. The clamp device of claim 15, wherein:
the drive gear comprises an annular gear including an interior channel;
the tab extends into interior channel; and
the displaceable clamp member is coupled to the drive gear via the tab such that the rotation of the drive gear causes a corresponding rotation of the displaceable clamp member.

17. The clamp device of claim 15, wherein:
the slot extends longitudinally along the displaceable clamp member; and
the tab is slidably coupled with the slot such that the displaceable clamp member is axially displaceable from a first position to a second position.

18. The clamp device of claim 15, wherein:
the drive assembly further includes a control element operable to effect the axial displacement of the displaceable clamp member; and
the control element is selectively moveable from a first position, in which the control element engages the displaceable clamp member, to a second position, in which the control element disengages the displaceable clamp member;

19. The clamp device of claim 15, further comprising a spring disposed around the displaceable clamp member.

20. A tool system comprising:
a first tool including:
a housing,
a stationary clamp member,
a displaceable clamp member, and
a drive assembly operatively connected to the displaceable clamp member; and
a second tool including:
a power assembly,
a motor assembly operatively connected to the power assembly,
wherein the second tool removably connects to the first tool such that, when connected, the motor assembly of the second tool engages the drive assembly of the first tool.

21. The tool system of claim 20, wherein:
the first tool comprises a clamp device; and
the second tool comprises a screwdriver.

22. The tool system of claim 20, wherein the housing of the first tool comprises a receptacle configured to receive the second tool.

23. The tool system of claim 20, wherein:
the displaceable clamp member of the first tool further comprises a slot formed therein;
the drive assembly of the first tool comprises a drive gear including a tab configured to mate with the slot; and
the motor assembly of the second tool rotates the drive gear.

24. The clamp device of claim 20, wherein the stationary clamp member is removable from the clamp device.

25. The clamp device of claim 20, wherein the stationary clamp member is repositionable on the clamp device.

26. The clamp device of claim 20, further comprising a biasing member operable to axially displace the displaceable clamp member without the aid of the motor.

27. The clamp device of claim 26, wherein the biasing member comprises a spring disposed around the displaceable clamp member.

28. A method of clamping a workpiece comprising:
providing a handheld clamp device including:
an actuator,
a stationary clamp member,
a displaceable clamp member,
a drive assembly operatively connected to the displaceable clamp member, and
a motor assembly operatively connected to the drive assembly,
and a control element moveable from a first position, in which the control element engages the displaceable clamp member, to a second position, in which the control element disengages the displaceable clamp member; and
engaging the actuator to move the control element from the first position to the second position.
